(19) United States
(12) Patent Application Publication
(10) Pub. No.: US 2026/0301686 A1
(43) Pub. Date: Oct. 1, 2026

(54) GATE DRIVER AND DISPLAY DEVICE INCLUDING THE SAME

(71) Applicant: LG Display Co., Ltd., Seoul (KR)

(72) Inventor: Woo Kyu SANG, Paju-si (KR)

(73) Assignee: LG Display Co., Ltd., Seoul (KR)

(21) Appl. No.: 19/455,108

(22) Filed: Jan. 21, 2026

(30) Foreign Application Priority Data
Mar. 31, 2025 (KR) 10-2025-0041246

(51) Int. Cl. G09G 3/3266; G09G 3/20; G09G 3/3233

(52) U.S. Cl. CPC G09G 3/3266; G09G 3/2074; G09G 3/3233; G09G 2300/0804; G09G 2300/0819; G09G 2300/0852; G09G 2300/0861; G09G 2310/0286; G09G 2310/0297; G09G 2310/06; G09G 2310/08; G09G 2320/0673; G09G 2330/023

(57) ABSTRACT

A gate driver according to an embodiment and a display device including the same are disclosed. The gate driver includes a control signal output part configured to generate a control signal based on a control clock signal and a carry signal; a control signal selection part configured to transfer one of the control signal generated from the control signal output part and a low-potential voltage applied from a power line; a scan signal output part configured to generate a scan signal according to potentials of a first control node and a second control node that are charged or discharged according to a gate clock signal; and a scan signal selection part configured to selectively output the scan signal generated from the scan signal output part based on the control signal transferred from the control signal selection part.

### CROSS-REFERENCE TO RELATED APPLICATION

This application claims priority to and the benefit of Korean Patent Application No. 10-2025-0041246, filed Mar. 31, 2025, the disclosure of which is incorporated herein by reference in its entirety.

### BACKGROUND

### Technical Field

The present disclosure relates to a gate driver and a display device including the same.

### Description of Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, organic light-emitting diodes (referred to as “OLEDs”) are formed in each of pixels. These organic light display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a scan signal or a gate signal to the display panel, and a data driver that supplies a data signal to the display panel.

### BRIEF SUMMARY

Recently, display devices support variable refresh rate (VRR). In a gate driver of a display device, output of gate signals is blocked during a period of skipping frames. To this end, the gate driver further includes an output control circuit for controlling whether to output gate signals.

However, even when the display areas are not driven at different driving frequencies for each display area but are driven at the same driving frequency, power consumption increases because the output control circuit is driven.

The present disclosure solves, among others, the above-described technical problems.

The present disclosure provides a gate driver and a display device including the same.

It should be noted that technical features of the present disclosure are not limited to those above-described, and other features and characteristics of the present disclosure will be apparent to those skilled in the art from the following descriptions.

A gate driver according to embodiments of the present disclosure may include a control signal output part configured to generate a control signal based on a control clock signal and a carry signal; a control signal selection part configured to transfer one of the control signal generated from the control signal output part and a low-potential voltage applied from a power line; a scan signal output part configured to generate a scan signal according to potentials of a first control node and a second control node that are charged or discharged according to a gate clock signal; and a scan signal selection part configured to selectively output the scan signal generated from the scan signal output part based on the control signal transferred from the control signal selection part.

A display device according to embodiments of the present disclosure may include a display panel on which a plurality of data lines, a plurality of gate lines crossing the data lines, a plurality of power lines to which different constant voltages are applied, and a plurality of sub-pixels are arranged; a data driver configured to supply a data voltage of pixel data to the data lines; a gate driver configured to supply gate signals to the gate lines; and a timing controller configured to control operation timings of the data driver and the gate driver, wherein the gate driver includes a control signal output part configured to generate a control signal based on a control clock signal and a carry signal; a control signal selection part configured to transfer one of the control signal generated from the control signal output part and a low-potential voltage applied from a power line; a scan signal output part configured to generate a scan signal according to potentials of a first control node and a second control node that are charged or discharged according to a gate clock signal; and a scan signal selection part configured to selectively output the scan signal generated from the scan signal output part based on the control signal transferred from the control signal selection part.

According to the present disclosure, there is provided a selection circuit that selectively supplies a control signal to an output control circuit, and when the entire display area is driven at the same driving frequency, the selection circuit supplies a low-potential voltage in lieu of the control signal while inhibiting generation of the start pulse and clock signal to be applied to the output control circuit, thereby precluding operation of the output control circuit and consequently enabling reduction of power consumption.

The present disclosure may enable low-power driving because power consumption may be reduced.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram showing a display device according to an embodiment of the present disclosure;

FIG. 2 is a circuit diagram showing a pixel circuit according to an embodiment of the present disclosure;

FIG. 3 is waveform diagrams showing driving signals applied to the pixel circuit shown in FIG. 2 in a refresh frame period and a skip frame period;

FIG. 4 is a circuit diagram showing a pixel circuit according to another embodiment of the present disclosure;

FIG. 5 is waveform diagrams showing driving signals applied to the pixel circuit shown in FIG. 4 in a refresh frame period and a skip frame period;

FIG. 6 is a diagram showing an example of a display panel driven at multiple frequencies in one frame period;

FIG. 7 is a diagram showing an arrangement form of a gate driver according to an embodiment of the present disclosure;

FIG. 8 is a block diagram showing a gate driver according to a first embodiment of the present disclosure;

FIG. 9 is a diagram showing driving waveforms of the gate driver shown in FIG. 8;

FIGS. 10 to 13 are diagrams showing detailed circuits of the gate driver shown in FIG. 8;

FIG. 14 is a block diagram showing a gate driver according to a second embodiment of the present disclosure;

FIG. 15 is a diagram showing driving waveforms of the gate driver shown in FIG. 14;

FIG. 16 is a diagram showing a detailed circuit of the gate driver shown in FIG. 15;

FIG. 17 is a block diagram showing a gate driver according to a third embodiment of the present disclosure; and

FIG. 18 is a diagram showing a detailed circuit of the output controller shown in FIG. 17.

### DETAILED DESCRIPTION

Advantages and features of the present specification and methods of achieving them will become apparent with reference to example embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification provide support to the claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS), since carriers are holes, a source voltage is higher than a drain voltage such that holes may flow from a source to a drain. In the p-channel transistor, since holes flow from the source to the drain, a current flows from the source to the drain. It should be noted that a source and a drain of a transistor are not fixed. For example, a source and a drain may be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

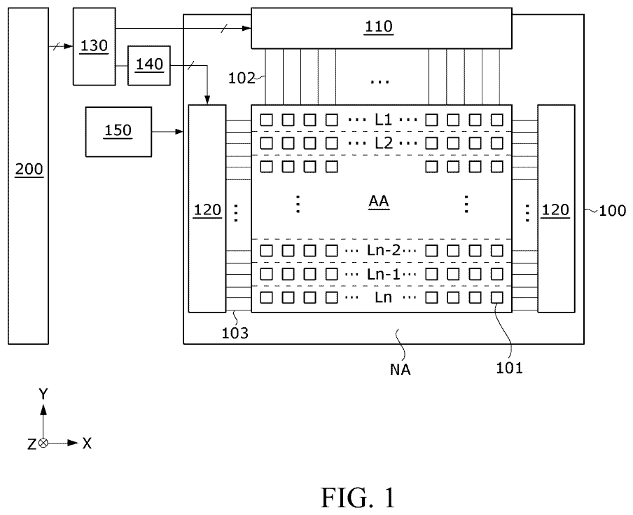

FIG. 1 is a block diagram showing a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 200 and outputs a voltage to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The power supply 150 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator may be implemented with a programmable gamma circuit that may adjust the voltage of each of the gamma reference voltages according to digital data. The timing controller 130, the host system 200, or a separate external device may update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit 110 and 120 may further include de-multiplexers (DEMUX) provided between the data driver 110 and the data lines 102, but embodiments of the present disclosure are not limited thereto. When the de-multiplexers are provided between output terminals of the data driver 110 and the data lines 102, the number of channels (or the number of output terminals) of the data driver 110 to be electrically connected to the data lines 102 may be reduced.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 may be provided in the non-display areas NA on both sides of the display panel 100 with the display area AA of the display panel interposed therebetween and may supply gate pulses on both sides of the gate lines 103 by a double feeding method. The gate driver 120 sequentially outputs pulses of gate signals to the gate lines 103 under the control of the timing controller 130. The gate driver 120 may sequentially supply the gate signals to the gate lines 103 by shifting the pulses of the gate signals using a shift register or an edge trigger. The gate driver 120 may include a plurality of gate drivers. Each of the gate drivers may be implemented as a shift register or an edge trigger.

In an embodiment where a plurality of gate signals is applied to each of the pixels, the gate driver 120 may include a plurality of shift registers. The gate signals may include scan signals and light emission signals (or EM signals) input to the pixel circuit through a plurality of gate lines.

The gate driver 120 may include a scan driver, and an EM driver.

The scan driver outputs a scan signal SCAN in response to a start pulse and a shift clock output from the timing controller 130, and shifts the scan signal SCAN in sync with a shift clock timing. The EM driver outputs an EM signal EM in response to the start pulse and the shift clock output from the timing controller 130, and sequentially shifts the EM signal EM according to the shift clock. Accordingly, the scan signal SCAN, and the EM signal EM are sequentially supplied to the gate lines 103 of the pixel lines L1 to Ln.

The timing controller 130 receives digital video data of an input image and a timing signal synchronized with this data from the host system 200. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The timing controller 130 may analyze an input image for each frame, generate a MUX signal for controlling the output control circuit that selectively outputs gate signals according to the analyzed result as well as clock signals, and provide the generated MUX signal and clock signal to the shift registers of the gate driver 120 through a level shifter 140.

For example, the timing controller 130 may compare an image of a previous frame with an image of a current frame and identify pixel positions where the image changes according to the comparison result. The timing controller 130 may divide the display area into a plurality of sub-display areas based on the identified pixel positions and generate a MUX signal and clock signals for this purpose.

The timing controller 130 may generate a MUX signal and a clock signal in a multi-frequency driving mode in which the display areas are driven at different driving frequencies for each display area. The timing controller 130 generates only a MUX signal in a normal driving mode in which the entire display area is driven at the same driving frequency, and does not generate a clock signal and a start pulse for driving the output control circuit.

Here, an example is described in which the timing controller identifies the positions of pixels where an image changes, but the present disclosure is not limited thereto. For example, a host system may identify the positions of pixels where an image changes and provide the identified pixel positions to the timing controller.

The host system 200 may scale an image signal from a video source according to the resolution of the display panel 100, and may transmit it to the timing controller 130 together with the timing signals.

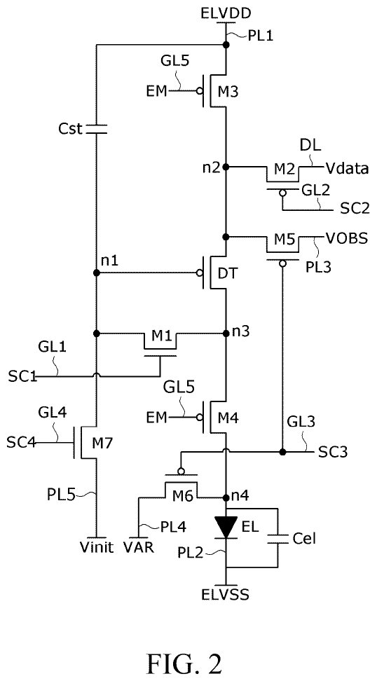

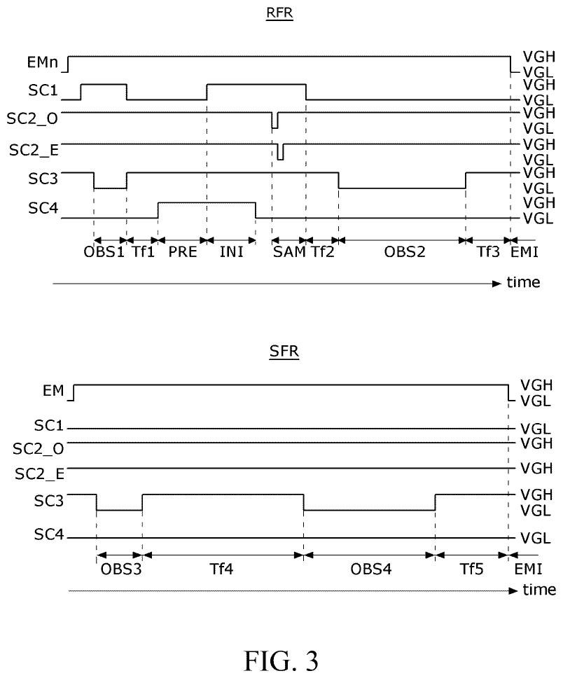

FIG. 2 is a circuit diagram showing a pixel circuit according to an embodiment of the present disclosure. FIG. 3 is waveform diagrams showing driving signals applied to the pixel circuit shown in FIG. 2 in a refresh frame period and a skip frame period. In FIG. 3, a second scan signal SC2_O is a gate signal that is applied to subpixels of an odd-numbered pixel line in synchronization with an odd-numbered data voltage Vdata_O. A second scan signal SC2_E is a gate signal that is applied to subpixels of an even-numbered pixel line in synchronization with an even-numbered data voltage Vdata_E.

Referring to FIGS. 2 and 3, the pixel circuit includes a light-emitting element EL, a driving element DT that drives the light-emitting element EL, a plurality of switch elements M1 to M7, and a capacitor Cst.

Each of first and seventh switch elements M1 and M7 may be implemented as an n-channel oxide TFT. Each of the driving element DT and second, third, fourth, fifth, and sixth switch elements M2, M3, M4, M5, and M6 may be implemented as a p-channel LTPS TFT. The first and seventh switch elements M1 and M7 are turned on in response to a gate high voltage VGH of a corresponding gate signal in FIG. 3, and are turned off in response to a gate low voltage VGL of the corresponding gate signal. The second, third, fourth, fifth, and sixth switch elements M2, M3, M4, M5, and M6 are turned on in response to a gate low voltage VGL of a corresponding gate signal in FIG. 3, and are turned off in response to a gate high voltage VGH of the corresponding gate signal.

The pixel circuit is connected to a data line DL to which a data voltage Vdata of pixel data is applied, and gate lines GL1, GL2, GL3, GL4, and GL5 to which the gate signals SC1, SC2, SC3, SC4, and EM are applied. The data voltage Vdata is applied to the data line DL in a sampling period of a refresh frame period.

A pixel driving voltage ELVDD and a pixel ground voltage ELVSS are set to voltages at which the driving element DT can operate in a saturation region. The pixel driving voltage ELVDD may be set to a voltage of 2 [V] to 3 [V], and the pixel ground voltage ELVSS may be set to a voltage of −8 [V] to −10 [V], but embodiments of the present disclosure are not limited thereto. The gate high voltage VGH may be set to a voltage higher than the pixel driving voltage ELVDD, and the gate low voltage VGL may be set to a voltage lower than the pixel ground voltage ELVSS, but embodiments of the present disclosure are not limited thereto.

The data voltage Vdata may have a dynamic range of 2 [V] to 6 [V]. Within the dynamic range, a voltage level of the data voltage Vdata is selected according to a grayscale value of pixel data. An initialization voltage Vinit may be set to a voltage lower than a lower limit voltage of the data voltage Vdata and higher than the pixel ground voltage ELVSS. For example, when the lower limit voltage of the data voltage Vdata is 2 [V], and the pixel ground voltage ELVSS is −9 [V], the initialization voltage Vinit may be set to a voltage of −5 [V] to −7 [V].

The gate signals SC1, SC2, SC3, SC4, and EM include pulses that swing between the gate high voltage VGH and the gate low voltage VGL.

The driving element DT includes a gate electrode connected to a first node n1, a first electrode connected to a second node n2, and a second electrode connected to a third node n3. The capacitor Cst is connected between a first power line PL1 to which the pixel driving voltage ELVDD is applied and the first node n1, and suppresses fluctuation of a gate-source voltage Vgs of the driving element DT.

The light-emitting element EL includes an anode electrode connected to a fourth node n4 and a cathode electrode connected to a second power line PL2 to which the pixel ground voltage ELVSS is applied. The light-emitting element EL may be implemented as an OLED. The OLED includes the parasitic capacitance Cel due to a stacked structure.

The first switch element M1 is connected between the first node n1 and the third node n3, and is turned on in response to the gate high voltage VGH of the first scan signal SC1. When the first switch element M1 is turned on, the first node n1 is electrically connected to the third node n3. The second switch element M2 is connected between the data line DL and the second node n2, and is turned on in response to the gate low voltage VGL of the second scan signal SC2. When the second switch element M2 is turned on, the data line DL is electrically connected to the second node n2.

The third switch element M3 is connected between the first power line PL1 and the second node n2, and is turned on in response to the gate low voltage VGL of the EM signal EM. When the third switch element M3 is turned on, the pixel driving voltage ELVDD is applied to the second node n2. The fourth switch element M4 is connected between the third node n3 and the fourth node n4, and is turned on in response to the gate low voltage VGL of the EM signal EM. When the fourth switch element M4 is turned on, the third node n3 is electrically connected to the fourth node n4.

The fifth switch element M5 is connected between the second node n2 and a third power line PL3 to which the on bias voltage VOBS is applied, and is turned on in response to the gate low voltage VGL of the third scan signal SC3. When the fifth switch element M5 is turned on, the on bias voltage VOBS is applied to the second node n2. The sixth switch element M6 is connected between the fourth node n4 and a fourth power line PL4 to which the second initialization voltage VAR is applied, and is turned on in response to the gate low voltage VGL of the third scan signal SC3. When the sixth switch element M6 is turned on, the second initialization voltage VAR is applied to the anode electrode of the light-emitting element EL connected to the fourth node n4.

The on bias voltage VOBS is an on bias stress voltage that is applied to the driving element DT to reduce a difference in hysteresis characteristic when the driving element DT is turned on/off. The on bias voltage VOBS is lower than the pixel driving voltage ELVDD and may be varied within a voltage range partially overlapping the dynamic range of the data voltage Vdata. For example, when the dynamic range of the data voltage Vdata is 2 [V] to 6 [V], the on bias voltage VOBS may be varied in a range of 4 [V] to 8 [V].

The second initialization voltage VAR discharges the parasitic capacitance (Cel) of the light-emitting element (EL) to reset the anode voltage of the light-emitting element (EL). A luminance level of the pixels 101 at a low grayscale may be optimized by appropriately adjusting the anode voltage according to the second initialization voltage VAR. The second initialization voltage VAR may be varied. For example, when the dynamic range of the data voltage Vdata is 2 [V] to 6 [V], the second initialization voltage VAR may be varied in a range of −4 [V] to −5 [V].

The seventh switch element M7 is connected between the first node n1 and a fifth power line PL5 to which the first initialization voltage Vinit is applied, and is turned on in response to the gate high voltage VGH of the fourth scan signal SC4. When the seventh switch element M7 is turned on, the first initialization voltage Vinit is applied to the capacitor Cst connected to the first node n1 and the gate electrode of the driving element DT.

The pixel circuit may receive the refresh driving signals as input, may be charged to the data voltage of the pixel data, and may be driven at the refresh frequency during the refresh frame period RFR. The refresh frame period RFR may be divided into a first on bias period OBS1, a first initialization period PRE, a second initialization period INI, a sampling period SAM, a second on bias period OBS2, and an emission period EMI.

A first floating period Tf1 may be set between the first on bias period OBS1 and the first initialization period PRE. A second floating period Tf2 may be set between the sampling period SAM and the second on bias period OBS2. A third floating period Tf3 may be set between the second on bias period OBS2 and the emission period EMI. During the floating periods Tf1, Tf2, and Tf3, since all the first to seventh switch elements M1 to M7 are in an off state, the first to fourth nodes n1, n2, n3, and n4 are brought into a floating state and maintained in previous state.

During the first on bias period OBS1, the fifth and sixth switch elements M5 and M6 are turned on, the on bias voltage VOBS is applied to the second node n2, and the second initialization voltage VAR is applied to the fourth node n4. During the first on bias period OBS1, the first switch element M1 is turned on, and the first node n1 is electrically connected to the third node n3.

During the first initialization period PRE, the seventh switch element M7 is turned on, and the initialization voltage Vinit is applied to the first node n1. During the first initialization period PRE, the light-emitting element EL is in an off state and does not emit light. During the second initialization period INI, the first and seventh switch elements M1 and M7 are turned on, the initialization voltage Vinit is applied to the first and third nodes n1 and n3, and the initialization voltage Vinit is also applied to the second node n2 via the driving element DT that is maintained in an on state.

During the sampling period SAM, the second switch element M2 is turned on in response to the gate low voltage VGL of the second scan signal SC2. In this case, the data voltage Vdata is applied to the second node n2, and the data voltage Vdata is applied to the first and third nodes n1 and n3 via the driving element DT in the on state. During the second on bias period OBS2, the fifth and sixth switch elements M5 and M6 are turned on, the on bias voltage VOBS is applied to the second node n2, and the second initialization voltage VAR is applied to the fourth node n4.

During the emission period EMI of the refresh frame period RFR, the third and fourth switch elements M3 and M4 are turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

The pixel circuit may receive the skip driving signals as input, charge a voltage of pixel data, and may be driven at the skip driving frequency during the skip frame period SFR. The skip frame period SFR may be divided into a third on bias period OBS3, a fourth on bias period OBS4, and an emission period EMI. A fourth floating period Tf4 may be set between the third on bias period OBS3 and the fourth on bias period OBS4. A fifth floating period Tf5 may be set between the fourth on bias period OBS4 and the emission period EMI. During the fourth and fifth floating periods TF4 and Tf5, since all the first to seventh switch elements M1 to M7 are in the off state, the first to fourth nodes n1, n2, n3, and n4 are brought into the floating state.

During the third and fourth on bias periods OBS3 and OBS4, the fifth and sixth switch elements M5 and M6 are turned on, the on bias voltage VOBS is applied to the second node n2, and the second initialization voltage VAR is applied to the fourth node n4.

During the emission period EMI of the skip frame period SFR, the third and fourth switch elements M3 and M4 are turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

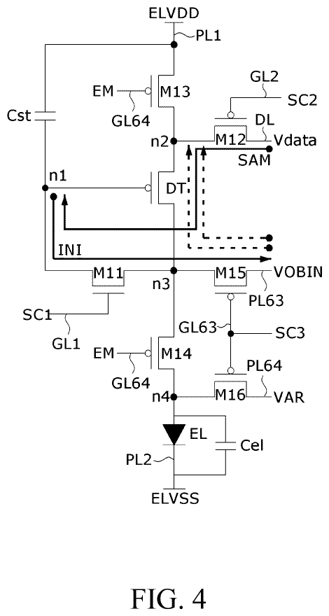

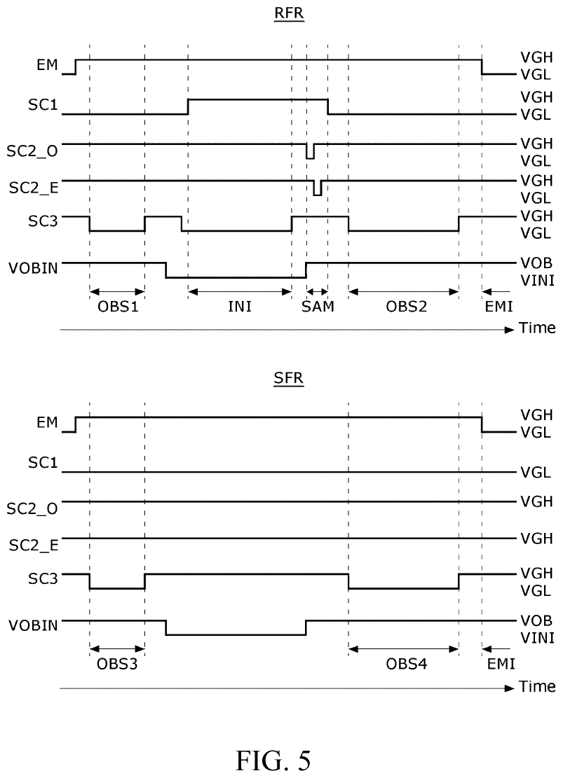

FIG. 4 is a circuit diagram showing a pixel circuit according to another embodiment of the present disclosure. FIG. 5 is waveform diagrams showing driving signals applied to the pixel circuit shown in FIG. 4 in a refresh frame period and a skip frame period.

Referring to FIGS. 4 and 5, the pixel circuit includes a light-emitting element EL, a driving element DT that drives the light-emitting element EL, a plurality of switch elements M11 to M16, and a capacitor Cst. The pixel circuit is connected to a data line DL, gate lines GL1, GL2, GL63, and GL64, and power lines PL1, PL2, PL63, and PL64.

A first switch element M11 may be implemented as an n-channel oxide TFT. Each of the driving element DT and second, third, fourth, fifth, and sixth switch elements M12, M13, M14, M15, and M16 may be implemented as a p-channel LTPS TFT. The first switch element T1 is turned on in response to a gate high voltage VGH of a first scan signal SC1 and is turned off in response to a gate low voltage VGL of the first scan signal SC1 in FIG. 5. The second, third, fourth, fifth, and sixth switch elements M12, M13, M14, M15, and M16 are turned on in response to gate low voltages VGL of corresponding gate signals SC2, SC3, and EM and are turned off in response to gate high voltages VGH of the corresponding gate signals SC2, SC3, and EM in FIG. 5.

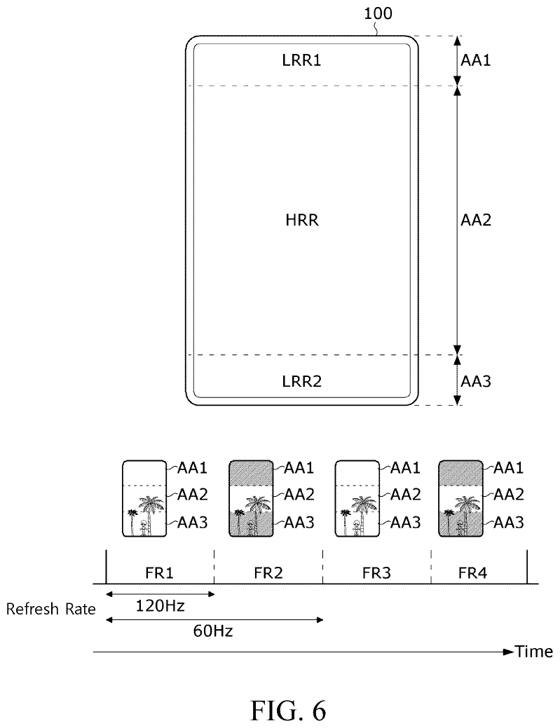

The first switch element M11 is connected between a first node n1 and a third node n3, and is turned on in response to the gate high voltage VGH of the first scan signal SC1 in an initialization period INI and a sampling period SAM of a refresh frame period RFR as illustrated in FIG. 6. When the first switch element M11 is turned on, the first node n1 is electrically connected to the third node n3.

The second switch element M12 is connected between the data line DL and a second node n2, and is turned on in response to the gate low voltage VGL of the second scan signal SC2 in the sampling period SAM of the refresh frame period RFR as illustrated in FIG. 5. When the second switch element M12 is turned on, the data line DL is electrically connected to the second node n2.

The third switch element M13 is connected between the first power line PL1 and the second node n2, and is turned on in response to the gate low voltage VGL of the EM signal EM in an emission period EMI as illustrated in FIG. 5. When the third switch element M13 is turned on, the pixel driving voltage ELVDD is applied to the second node n2.

The fourth switch element M14 is connected between the third node n3 and a fourth node n4, and is turned on in response to the gate low voltage VGL of the EM signal EM in the emission period EMI as illustrated in FIG. 5. When the fourth switch element M14 is turned on, the third node n3 is electrically connected to the fourth node n4.

The fifth switch element M15 is connected between the third node n3 and a third power line PL63 to which a compensation voltage VOBIN is applied, and is turned on in response to the gate low voltage VGL of the third scan signal SC3. The compensation voltage VOBIN is an alternating-current voltage that swings between an on bias voltage VOB and an initialization voltage VINI as illustrated in FIG. 5. The on bias voltage VOB is a voltage higher than the initialization voltage VINI. The on bias voltage VOB is applied to the third node n3 via the fifth switch element T5 during on bias periods OBS1 to OBS5. The initialization voltage VINI is applied to the third node n3 via the fifth switch element M15 during the initialization period INI. The on bias voltage VOB corresponds to the on bias voltage VOBS in the above-described embodiment, and the initialization voltage VINI corresponds to the first initialization voltage Vinit in the above-described embodiment.

The sixth switch element M16 is connected between the fourth node n4 and a fourth power line PL64, and is turned on in response to the gate low voltage VGL of the third scan signal SC3. The second initialization voltage VAR is applied to the fourth node n4 via the sixth switch element M16 during the on bias periods OBS1 to OBS4.

FIG. 6 is a diagram showing an example of a display panel driven at multiple frequencies in one frame period.

Referring to FIG. 6, a display area AA of the display panel 100 may be divided into multiple sub-display areas AA1, AA2, and AA3 and may reproduce an input image at different refresh rates in one frame period. In the display panel 100, the sub-display areas AA1, AA2, and AA3 mean local pixel areas that are not physically separated and in which driving frequencies of pixels are controlled independently according to the refresh rates. The sub-display areas AA1, AA2, and AA3 include pixels and signal wires having substantially the same structures. When the pixels of the sub-display areas AA1, AA2, and AA3 are driven at a variable refresh rate, the sub-display areas AA1, AA2, and AA3 are local areas having the pixels with different driving frequencies in the display area AA.

In the normal driving mode, all areas AA1, AA2, and AA3 may be driven at the same refresh driving frequency, for example, 120 Hz.

In the multi-frequency driving mode, the first and third areas AA1 and AA3 may be driven at a skip driving frequency, for example, 60 Hz, and the second region AA2 may be driven at a refresh driving frequency, for example, 120 Hz.

The refresh driving frequency is a driving frequency of a pixel that occurs when pixel data is written as much as Frames Per Second (FPS) that changes according to a variable refresh rate. The skip driving frequency is a driving frequency of a pixel that maintains a data voltage of pixel data charged in a previous refresh frame without new pixel data being written. Therefore, when pixels are skip-driven, since there are no initialization and data writing steps for the pixels, power consumption in the display panel 100 and the display panel driving circuit during skip driving may be significantly lower than during refresh driving.

In an embodiment of the present disclosure, the normal driving mode refers to a mode in which a plurality of gate signals is sequentially output in the entire display area and all pixels are driven in a refresh frame period. The multi-frequency driving mode may refer to a mode in which a gate signal is maintained at a low voltage level in some display areas and the corresponding pixels in those areas are driven in a skip frame period.

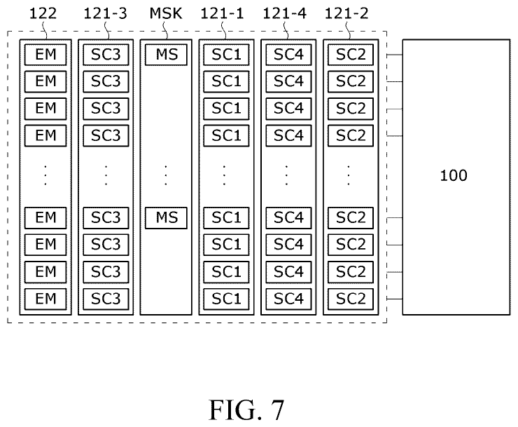

FIG. 7 is a diagram showing an arrangement form of a gate driver according to an embodiment of the present disclosure.

Referring to FIG. 7, the gate driver according to an embodiment of the present disclosure may include a first scan driver 121-1, a second scan driver 121-2, a third scan driver 121-3, a fourth scan driver 121-4, and an EM driver 122. In addition, the embodiment further includes an output controller MSK that controls whether to output the first and second scan signals and the fourth scan signal.

In the multi-frequency driving mode, the first scan driver 121-1, the second scan driver 121-2, and the fourth scan driver 121-4 are controlled by a control signal MS generated from the output controller MSK so that a first scan signal SC1, a second scan signal SC2, and a fourth scan signal SC4 among first to fourth scan signals SC1, SC2, SC3, and SC4 and an EM signal EM are not output to the pixel circuit of FIG. 2 driven in a skip frame period.

The output controller MSK may be disposed on a per-block basis, wherein each block includes a predetermined number of gate drivers, so that the same control signal can be provided to a plurality of gate drivers, but is not limited thereto. For example, the output controller MSK may be disposed one for each gate driver so as to provide a control signal to each gate driver.

In the following, the first scan driver 121-1 and the fourth scan driver 121-4 will be described. Since the first scan driver 121-1 and the fourth scan driver 121-4 have the same configuration and operating principle, only the driving and operation of the first scan driver 121-1 will be described.

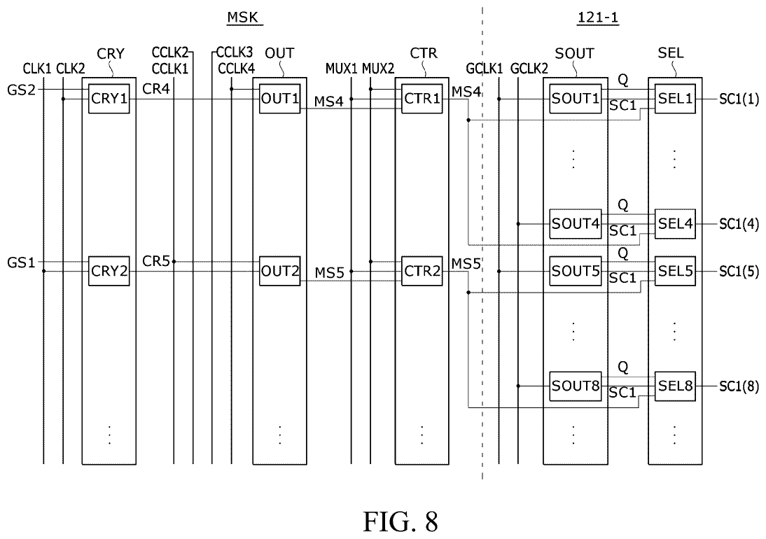

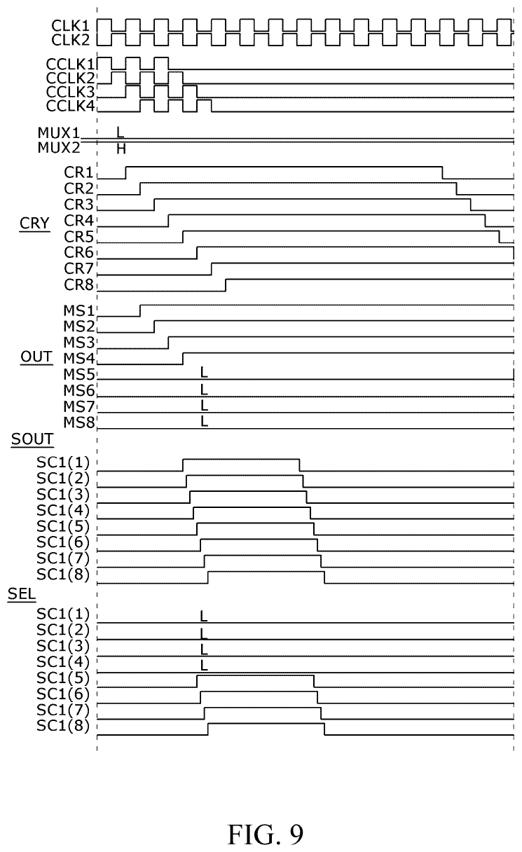

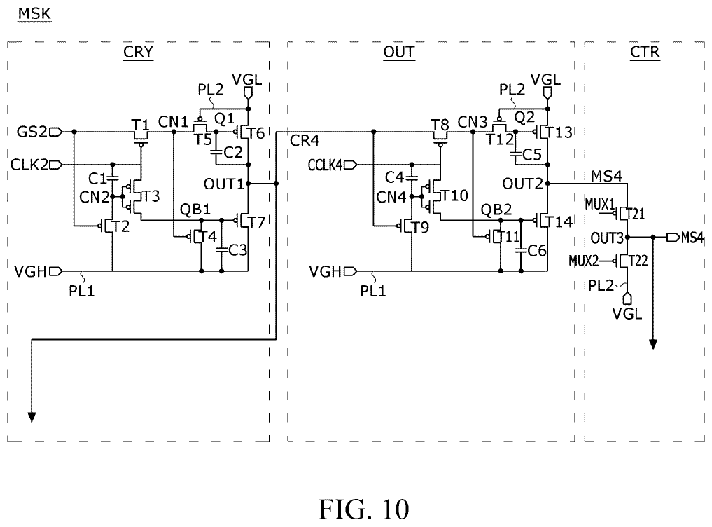

FIG. 8 is a block diagram showing a gate driver according to a first embodiment of the present disclosure. FIG. 9 is a diagram showing driving waveforms of the gate driver shown in FIG. 8. FIGS. 10 to 13 are diagrams showing detailed circuits of the gate driver shown in FIG. 8.

Referring to FIGS. 8 to 9, a gate driver according to a first embodiment of the present disclosure may include an output controller MSK and a first scan driver 121-1 that outputs a first scan signal. The output controller MSK may include a carry signal transfer part CRY, a control signal transfer part OUT, and a control signal selection part CTR.

The carry signal transfer part CRY may receive selected gate signals GS1 and GS2 and clock signals CLK1 and CLK2. The gate signals GS1 and GS2 may be output from another gate driver and may be gate signals that are sequentially shifted on a pixel line basis, for example, they may be EM signals or separate gate signals. The carry signal transfer part CRY may output carry signals CR4 and CR5 under the control of the timing controller.

The control signal transfer part OUT may receive the carry signals CR4 and CR5 and modulated control clock signals CCLK1, CCLK2, CCLK3, and CCLK4 and output control signals MS4 and MS5. The modulated control clock signals CCLK1, CCLK2, CCLK3, and CCLK4 may be generated by the timing controller.

The control signal selection part CTR may receive MUX signals MUX1 and MUX2 and selectively output the control signal MS4 or MS5. The MUX signals MUX1 and MUX2 may be generated by the timing controller according to a refresh rate of an input image. For example, the control signal selection part CTR may output the control signals MS4 and MS5 or output a low-potential voltage VGL.

As an example, as shown in FIG. 9, the control signal transfer part OUT outputs only control signals MS1, MS2, MS3, and MS4 by the modulated control clock signals CCLK1, CCLK2, CCLK3, and CCLK4 in the multi-frequency driving mode.

Referring to FIG. 10, which illustrates an example of a signal transfer part included in the output controller MSK of the present disclosure, the output controller may include a carry signal transfer part CRY, a control signal transfer part OUT, and a control signal selection part CTR.

The carry signal transfer part CRY outputs a carry signal CR4 using a gate signal GS2 and a clock signal CLK2. The carry signal transfer part CRY includes a first transistor T1, a second transistor T2, a third transistor T3, a fourth transistor T4, a fifth transistor T5, a sixth transistor T6, a seventh transistor T7, a first capacitor C1, a second capacitor C2, and a third capacitor C3.

The first transistor T1 is turned on according to the clock signal CLK2 and applies the gate signal GS2 to a first connection node CN1. The first transistor T1 includes a gate electrode to which the clock signal CLK2 is applied, a first electrode to which the gate signal GS2 is applied, and a second electrode connected to the first connection node CN1.

The second transistor T2 is turned on according to the gate signal GS2, and charges a second connection node CN2 to the high-potential voltage VGH by connecting the second connection node CN2 to a first power line PL1 to which a high-potential voltage VGH is applied. The second transistor T2 includes a gate electrode to which the gate signal GS2 is applied, a first electrode connected to the second connection node CN2, and a second electrode connected to the first power line PL1.

The third transistor T3 is turned on according to a potential of the second connection node CN2 and applies the clock signal CLK2 to a QB1 node QB1. The third transistor T3 includes a gate electrode connected to the second connection node CN2, a first electrode to which the clock signal CLK2 is applied, and a second electrode connected to the QB1 node QB1.

The third transistor T3 may have a dual gate structure to minimize current leakage.

The fourth transistor T4 is turned on according to a potential of the first connection node CN1, and charges the QB1 node QB1 to the high-potential voltage VGH by connecting the first power line PL1 to the QB1 node QB1. The fourth transistor T4 includes a gate electrode connected to the first connection node CN1, a first electrode connected to the QB1 node QB1, and a second electrode connected to the first power line PL1.

The fifth transistor T5 is turned on according to a potential of the low-potential voltage VGL and connects the first connection node CN1 to a Q1 node Q1. The fifth transistor T5 includes a gate electrode connected to a second power line PL2 to which the low-potential voltage VGL is applied, a first electrode connected to the first connection node CN1, and a second electrode connected to the Q1 node Q1.

The sixth transistor T6 is turned on according to a potential of the Q1 node Q1 and outputs the low-potential voltage VGL to a first output node OUT1. The sixth transistor T6 includes a gate electrode connected to the Q1 node Q1, a first electrode connected to the second power line PL2, and a second electrode connected to the first output node OUT1.

The seventh transistor T7 is turned on according to a potential of the QB1 node QB1 and outputs the high-potential voltage VGH to the first output node OUT1. The seventh transistor T7 includes a gate electrode connected to the QB1 node QB1, a first electrode connected to the first output node OUT1, and a second electrode connected to the first power line PL1.

The first capacitor C1 is connected between the gate electrode and the first electrode of the third transistor T3. The second capacitor C2 is connected between the gate electrode and the second electrode of the sixth transistor T6. The third capacitor C3 is connected between the gate electrode and the second electrode of the seventh transistor T7.

The control signal transfer part OUT outputs a control signal MS4 based on the carry signal CR4 and a control clock signal CCLK4. The control signal transfer part OUT includes an eighth transistor T8, a ninth transistor T9, a tenth transistor T10, an eleventh transistor T11, a twelfth transistor T12, a thirteenth transistor T13, a fourteenth transistor T14, a fourth capacitor C4, a fifth capacitor C5, and a sixth capacitor C6.

The eighth transistor T8 is turned on according to a control clock signal CCLK4 and applies the carry signal CR4 to a third connection node CN3. The eighth transistor T8 includes a gate electrode to which the control clock signal CCLK4 is applied, a first electrode to which the carry signal CR4 is applied, and a second electrode connected to the third connection node CN3.

The ninth transistor T9 is turned on according to the carry signal CR4, and charges a fourth connection node CN4 to the high-potential voltage VGH by connecting the fourth connection node CN4 to the first power line PL1 to which the high-potential voltage VGH is applied. The ninth transistor T9 includes a gate electrode to which the carry signal CR4 is applied, a first electrode connected to the fourth connection node CN4, and a second electrode connected to the first power line PL1.

The tenth transistor T10 is turned on according to a potential of the fourth connection node CN4 and applies the control clock signal CCLK4 to a QB2 node QB2. The tenth transistor T10 includes a gate electrode connected to the fourth connection node CN4, a first electrode to which the control clock signal CCLK4 is applied, and a second electrode connected to the QB2 node QB2.

The tenth transistor T10 may have a dual gate structure to minimize current leakage.

The eleventh transistor T11 is turned on according to a potential of the third connection node CN3, and charges the QB2 node QB2 to the high-potential voltage VGH by connecting the first power line PL1 to the QB2 node QB2. The eleventh transistor T11 includes a gate electrode connected to the third connection node CN3, a first electrode connected to the QB2 node QB2, and a second electrode connected to the first power line PL1.

The twelfth transistor T12 is turned on according to a potential of the low-potential voltage VGL and connects the third connection node CN3 to a Q2 node Q2. The twelfth transistor T12 includes a gate electrode connected to a second power line PL2 to which the low-potential voltage VGL is applied, a first electrode connected to the third connection node CN3, and a second electrode connected to the Q2 node Q2.

The thirteenth transistor T13 is turned on according to a potential of the Q2 node Q2 and outputs the low-potential voltage VGL to a second output node OUT2. The thirteenth transistor T13 includes a gate electrode connected to the Q2 node Q2, a first electrode connected to the second power line PL2, and a second electrode connected to the second output node OUT2.

The fourteenth transistor T14 is turned on according to a potential of the QB2 node QB2 and outputs the high-potential voltage VGH to the second output node OUT2. The fourteenth transistor T14 includes a gate electrode connected to the QB2 node QB2, a first electrode connected to the second output node OUT2, and a second electrode connected to the first power line PL1.

The fourth capacitor C4 is connected between the gate electrode and the first electrode of the tenth transistor T10. The fifth capacitor C5 is connected between the gate electrode and the second electrode of the thirteenth transistor T13. The sixth capacitor C6 is connected between the gate electrode and the second electrode of the fourteenth transistor T14.

In this configuration, in the multi-frequency driving mode, the control signal transfer part OUT outputs a control signal at a high-level voltage or outputs a control signal at a low-level voltage depending on potentials of the control clock signals CCLK1, CCLK2, CCLK3, and CCLK4 that are modulated according to a driving frequency for each display area. For example, the control signal transfer part OUT outputs the control signal MS4 at a high-level voltage when the control clock signal CCLK4 is at a high-level voltage, and outputs the control signal MS4 at a low-level voltage when the control clock signal CCLK4 is at a low-level voltage.

On the other hand, in the normal driving mode, not only the control clock signals CCLK1, CCLK2, CCLK3, and CCLK4 applied to the control signal transfer part OUT are not generated, but also the clock signals CLK1 and CLK2 and the gate signals GS1 and GS2 applied to the carry signal transfer part CRY are not generated, whereby power consumption can be reduced.

The control signal selection part CTR may selectively output the control signal MS4 output from the control signal transfer part OUT or the low-potential voltage VGL. The control signal selection part CTR includes a twenty-first transistor T21 and a twenty-second transistor T22.

The twenty-first transistor T21 is turned on according to a potential of a first MUX signal MUX1 and outputs the control signal MS4 to a third output node OUT3. The twenty-first transistor T21 includes a gate electrode to which the first MUX signal MUX1 is applied, a first electrode connected to the second output node OUT2, and a second electrode connected to the third output node OUT3.

The twenty-second transistor T22 is turned on according to a potential of a second MUX signal MUX2 and outputs the low-potential voltage VGL to the third output node OUT3. The twenty-second transistor T22 includes a gate electrode to which the second MUX signal MUX2 is applied, a first electrode connected to the third output node OUT3, and a second electrode connected to the second power line PL2.

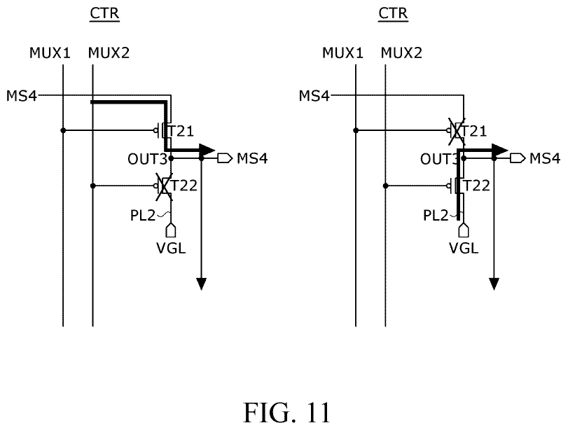

As shown in FIG. 11, in the multi-frequency driving mode, the first MUX signal MUX1 at a low-level voltage and the second MUX signal MUX2 at a high-level voltage are applied to the control signal selection part CTR, so that the control signal MS4 transferred from the control signal transfer part OUT is output as it is.

On the other hand, in the normal driving mode, the first MUX signal MUX1 at a high-level voltage and the second MUX signal MUX2 at a low-level voltage are applied to the control signal selection part CTR, so that the low-potential voltage VGL is output.

All transistors constituting the gate driver according to the first embodiment of the present disclosure may be implemented as p-channel TFTs, but are not limited thereto. For example, all transistors may be implemented as n-channel TFTs, or some transistors may be implemented as n-channel TFTs.

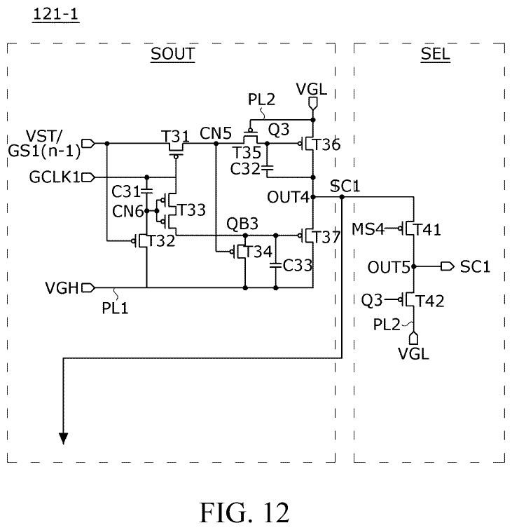

Referring to FIG. 12, which illustrates an example of a signal transfer part included in the first scan driver 121-1 of the present disclosure, the first scan driver includes a scan signal output part SOUT and a scan signal selection part SEL.

The scan signal output part SOUT may output a first scan signal using gate clock signals GCLK1 and GCLK2, and a start pulse VST or an (n−1)th gate signal GS(n−1) output from a previous signal transfer part. The scan signal output part SOUT includes a thirty-first transistor T31, a thirty-second transistor T32, a thirty-third transistor T33, a thirty-fourth transistor T34, a thirty-fifth transistor T35, a thirty-sixth transistor T36, a thirty-seventh transistor T37, a thirty-first capacitor C31, a thirty-second capacitor C32, and a thirty-third capacitor C33.

The thirty-first transistor T31 is turned on according to a gate clock signal GCLK1 and applies the start pulse VST or a gate signal GS1(n−1) output from a previous signal transfer part to a fifth connection node CN5. The thirty-first transistor T31 includes a gate electrode to which the gate clock signal GCLK1 is applied, a first electrode to which the start pulse VST or the gate signal GS1(n−1) output from a previous signal transfer part is applied, and a second electrode connected to the fifth connection node CN5.

The thirty-second transistor T32 is turned on according to the start pulse VST or the gate signal GS1(n−1) output from a previous signal transfer part and charges a sixth connection node CN6 to the high-potential voltage VGH by connecting the sixth connection node CN6 to a first power line PL1 to which a high-potential voltage VGH is applied. The thirty-second transistor T32 includes a gate electrode to which the start pulse VST or the gate signal GS1(n−1) output from a previous signal transfer part is applied, a first electrode connected to the sixth connection node CN6, and a second electrode connected to the first power line PL1.

The thirty-third transistor T33 is turned on according to a potential of the sixth connection node CN6 and applies the gate clock signal GCLK1 to a QB3 node QB3. The thirty-third transistor T33 includes a gate electrode connected to the sixth connection node CN6, a first electrode to which the gate clock signal GCLK1 is applied, and a second electrode connected to the QB3 node QB3.

The thirty-third transistor T33 may have a dual gate structure to minimize current leakage.

The thirty-fourth transistor T34 is turned on according to a potential of the fifth connection node CN5, and charges the QB3 node QB3 to the high-potential voltage VGH by connecting the first power line PL1 to the QB3 node QB3. The thirty-fourth transistor T34 includes a gate electrode connected to the fifth connection node CN5, a first electrode connected to the QB3 node QB3, and a second electrode connected to the first power line PL1.

The thirty-fifth transistor T35 is turned on according to a potential of the low-potential voltage VGL and connects the fifth connection node CN5 to a Q3 node Q3. The thirty-fifth transistor T35 includes a gate electrode connected to a second power line PL2 to which the low-potential voltage VGL is applied, a first electrode connected to the fifth connection node CN5, and a second electrode connected to the Q3 node Q3.

The thirty-sixth transistor T36 is turned on according to a potential of the Q3 node Q3 and outputs the low-potential voltage VGL to a fourth output node OUT4. The thirty-sixth transistor T36 includes a gate electrode connected to the Q3 node Q3, a first electrode connected to the second power line PL2, and a second electrode connected to the fourth output node OUT4.

The thirty-seventh transistor T37 is turned on according to a potential of the QB3 node QB3 and outputs the high-potential voltage VGH to the fourth output node OUT4. The thirty-seventh transistor T37 includes a gate electrode connected to the QB3 node QB3, a first electrode connected to the fourth output node OUT4, and a second electrode connected to the first power line PL1.

The thirty-first capacitor C31 is connected between the gate electrode and the first electrode of the thirty-third transistor T33. The thirty-second capacitor C32 is connected between the gate electrode and the second electrode of the thirty-sixth transistor T36. The thirty-third capacitor C33 is connected between the gate electrode and the second electrode of the thirty-seventh transistor T37.

The scan signal selection part SEL may selectively output the first scan signal SC1 or the low-potential voltage VGL based on potentials of the Q3 node Q3 and the control signal MS4. The scan signal selection part SEL includes a forty-first transistor T41 and a forty-second transistor T42.

The forty-first transistor T41 is turned on according to a potential of the control signal MS4 and outputs the first scan signal SC1 to a fifth output node OUT5. The forty-first transistor T41 includes a gate electrode to which the control signal MS4 is applied, a first electrode connected to the fourth output node OUT4, and a second electrode connected to the fifth output node OUT5.

The forty-second transistor T42 is turned on according to a potential of the Q3 node Q3 and outputs the low-potential voltage VGL to the fifth output node OUT5. The forty-second transistor T42 includes a gate electrode connected to the Q3 node Q3, a first electrode connected to the fifth output node OUT5, and a second electrode connected to the second power line PL2.

In this configuration, in the multi-frequency driving mode, the scan signal selection part SEL outputs the low-potential voltage VGL or the first scan signal SC1 to the fifth output node OUT5 according to a potential of the control signal MS4.

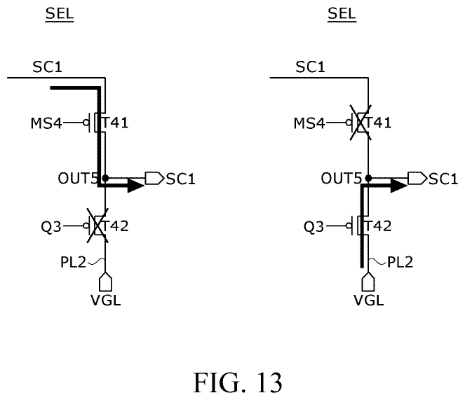

For example, as shown in FIG. 13, the scan signal selection part SEL outputs the first scan signal SC1 to the fifth output node OUT5 when the control signal MS4 is at a low-level voltage, and outputs the low-potential voltage VGL to the fifth output node OUT5 when the control signal MS4 is at a high-level voltage.

As an example, as shown in FIG. 9, the scan signal output part SOUT outputs only some second scan signals SC1(5), SC1(6), SC1(7), and SC1(8) according to the control signals MS1, MS2, MS3, and MS4.

On the other hand, in the normal driving mode, the scan signal selection part SEL outputs the first scan signal SC1.

Hereinafter, the configuration and operation of the second scan driver 121-2 will be described.

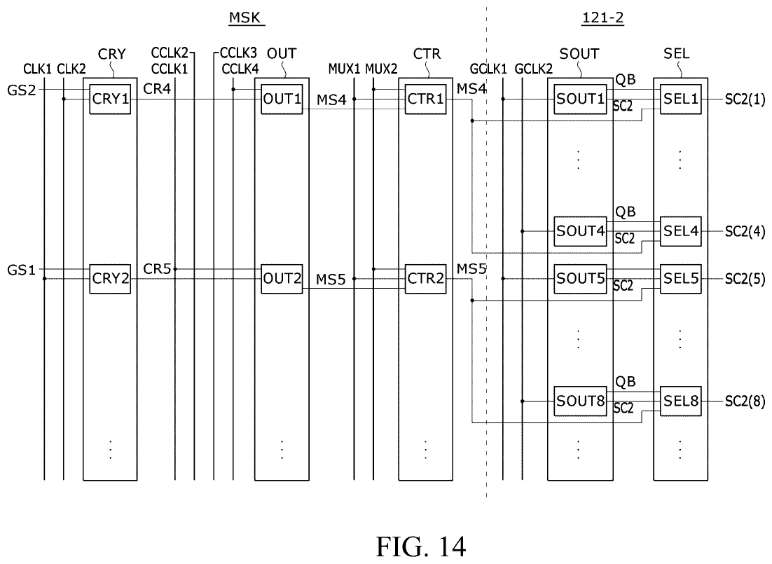

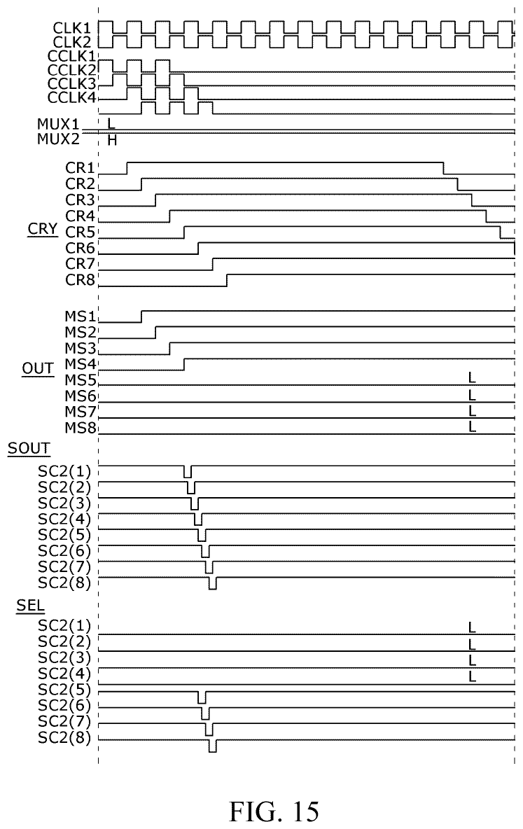

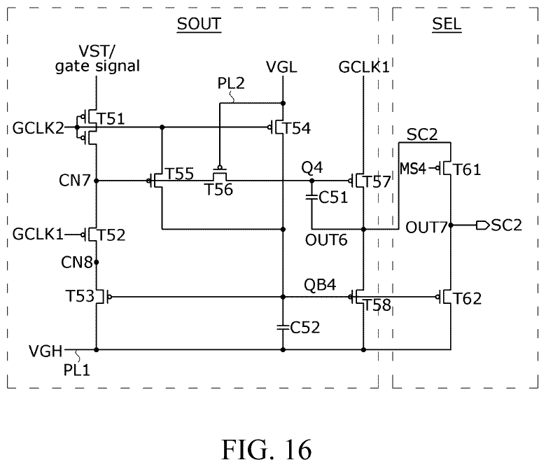

FIG. 14 is a block diagram showing a gate driver according to a second embodiment of the present disclosure. FIG. 15 is a diagram showing driving waveforms of the gate driver shown in FIG. 14. FIG. 16 is a diagram showing a detailed circuit of the gate driver shown in FIG. 15.

Referring to FIGS. 14 to 15, a gate driver according to a second embodiment of the present disclosure may include an output controller MSK and a second scan driver 121-2 that outputs a second scan signal. The output controller MSK may include a carry signal transfer part CRY, a control signal transfer part OUT, and a control signal selection part CTR.

The carry signal transfer part CRY may receive selected gate signals GS1 and GS2 and clock signals CLK1 and CLK2. The gate signals GS1 and GS2 may be output from other gate drivers and may be gate signals that are sequentially shifted on pixel line basis, for example, they may be EM signals or separate gate signals. The carry signal transfer part CRY may output carry signals CR4 and CR5 under the control of the timing controller.

In this case, the clock signals CLK1 and CLK2 may be two-phase clock signals having a phase difference of 180 degrees.

The control signal transfer part OUT may receive the carry signals CR4 and CR5 and control clock signals CCLK1, CCLK2, CCLK3, and CCLK4 and output control signals MS4 and MS5.

In this case, the control clock signals CCLK1, CCLK2, CCLK3, and CCLK4 may be four-phase signals having a phase difference of 90 degrees.

The control signal selection part CTR may receive MUX signals MUX1 and MUX2 and selectively output the control signal MS4 or MS5. The MUX signals MUX1 and MUX2 may be generated by the timing controller according to a refresh rate of an input image. For example, the control signal selection part CTR may output the control signals MS4 and MS5 or output the low-potential voltage VGL.

As an example, as shown in FIG. 15, the control signal transfer part OUT outputs only some control signals MS1, MS2, MS3, and MS4 by the modulated control clock signals CCLK1, CCLK2, CCLK3, and CCLK4 in the multi-frequency driving mode.

The second scan driver 121-2 selectively outputs a second scan signal or a low-potential voltage based on the control signal MS. The second scan driver 121-2 may include a scan signal output part SOUT and a scan signal selection part SEL.

The scan signal output part SOUT may output a second scan signal SC2 using gate clock signals GCLK1 and GCLK2, a start pulse VST, or a gate signal output from a previous signal transfer part.

The scan signal selection part SEL may selectively output one of the second scan signal SC2 and the low-potential voltage VGL based on potentials of a QB node QB and the control signal MS4.

As an example, as shown in FIG. 15, the scan signal output part SOUT outputs only some second scan signals SC2(5), SC2(6), SC2(7), and SC2(8) according to the control signals MS1, MS2, MS3, and MS4.

The output controller MSK constituting the gate driver according to the second embodiment has the same configuration and operation as the output controller of the first embodiment, and thus a description thereof will be omitted.

Referring to FIG. 16, which illustrates an example of a signal transfer part included in the second scan driver 121-2 of the present disclosure, the second scan driver may include a scan signal output part SOUT and a scan signal selection part SEL.

The scan signal output part SOUT may output a second scan signal SC2 using gate clock signals GCLK1 and GCLK2, and a start pulse VST or a gate signal output from a previous signal transfer part. The scan signal output part SOUT includes a fifty-first transistor T51, a fifty-second transistor T52, a fifty-third transistor T53, a fifty-fourth transistor T54, a fifty-fifth transistor T55, a fifty-sixth transistor T56, a fifty-seventh transistor T57, a fifty-eighth transistor T58, a fifty-first capacitor C51, and a fifty-second capacitor C52.

The fifty-first transistor T51 is turned on according to a potential of a gate clock signal GCLK2 and applies the start pulse VST or a gate signal output from a previous signal transfer part to a seventh connection node CN7. The fifty-first transistor T51 includes a gate electrode to which the gate clock signal GCLK2 is applied, a first electrode to which the start pulse VST or a gate signal output from a previous signal transfer part is applied, and a second electrode connected to the seventh connection node CN7.

The fifty-second transistor T52 is turned on according to a potential of a gate clock signal GCLK1 and connects the seventh connection node CN7 and an eighth connection node CN8. The fifty-second transistor T52 includes a gate electrode to which the gate clock signal GCLK1 is applied, a first electrode connected to the seventh connection node CN7, and a second electrode connected to the eighth connection node CN8.

The fifty-third transistor T53 is turned on according to a potential of a QB4 node QB4, and charges the eighth connection node CN8 to the high-potential voltage VGH by connecting the eighth connection node CN8 to a first power line PL1 to which a high-potential voltage VGH is applied. The fifty-third transistor T53 includes a gate electrode connected to the QB4 node QB4, a first electrode connected to the eighth connection node CN8, and a second electrode connected to the first power line PL1.

The fifty-fourth transistor T54 is turned on according to a potential of the gate clock signal GCLK2, and discharges the QB4 node QB4 up to the low-potential voltage by connecting a second power line PL2 to which a low-potential voltage VGL is applied to the QB4 node QB4. The fifty-fourth transistor T54 includes a gate electrode to which the gate clock signal GCLK2 is applied, a first electrode connected to the second power line PL2, and a second electrode connected to the QB4 node QB4.

The fifty-fifth transistor T55 is turned on according to a potential of the seventh connection node CN7 and applies the gate clock signal GCLK2 to the QB4 node QB4. The fifty-fifth transistor T55 includes a gate electrode connected to the seventh connection node CN7, a first electrode to which the gate clock signal GCLK2 is applied, and a second electrode connected to the QB4 node QB4.

The fifty-sixth transistor T56 is turned on according to the low-potential voltage and connects the seventh connection node CN7 and a Q4 node Q4. The fifty-sixth transistor T56 includes a gate electrode connected to the second power line PL2, a first electrode connected to the seventh connection node CN7, and a second electrode connected to the Q4 node Q4.

The fifty-seventh transistor T57 is turned on according to a potential of the Q4 node Q4 and applies the gate clock signal GCLK1 to a sixth output node OUT6. The fifty-seventh transistor T57 includes a gate electrode connected to the Q4 node Q4, a first electrode to which the gate clock signal GCLK1 is applied, and a second electrode connected to the sixth output node OUT6.

The fifty-eighth transistor T58 is turned on according to a potential of the QB4 node QB4 and applies the high-potential voltage VGH to the sixth output node OUT6. The fifty-eighth transistor T58 includes a gate electrode connected to the QB4 node QB4, a first electrode connected to the sixth output node OUT6, and a second electrode connected to the first power line PL1.

The fifty-first capacitor C51 is connected between the gate electrode and the second electrode of the fifty-seventh transistor T57. The fifty-second capacitor C52 is connected between the gate electrode and the second electrode of the fifty-eighth transistor T58.

The scan signal selection part SEL may selectively output a second scan signal SC2 based on potentials of the QB4 node QB4 and the control signal MS. The scan signal selection part SEL includes a sixty-first transistor T61 and a sixty-second transistor T62.

The sixty-first transistor T61 is turned on according to a potential of the control signal MS4 and applies the second scan signal to a seventh output node OUT7. The sixty-first transistor T61 includes a gate electrode to which the control signal MS4 is applied, a first electrode connected to the sixth output node OUT6, and a second electrode connected to the seventh output node OUT7.

The sixty-second transistor T62 is turned on according to a potential of the QB4 node QB4 and applies the high-potential voltage VGH to the sixth output node OUT6. The sixty-second transistor T62 includes a gate electrode connected to the QB4 node QB4, a first electrode connected to the seventh output node OUT7, and a second electrode connected to the first power line PL1.

In this configuration, in the multi-frequency driving mode, the scan signal selection part SEL outputs the second scan signal SC2 when the control signal MS4 is at a low-level voltage, and outputs the low-potential voltage VGL when the control signal MS4 is at a high-level voltage.

On the other hand, in the normal driving mode, the scan signal selection part SEL outputs the second scan signal SC2.

In the embodiment, it is intended to control the output controller MSK using one MUX signal.

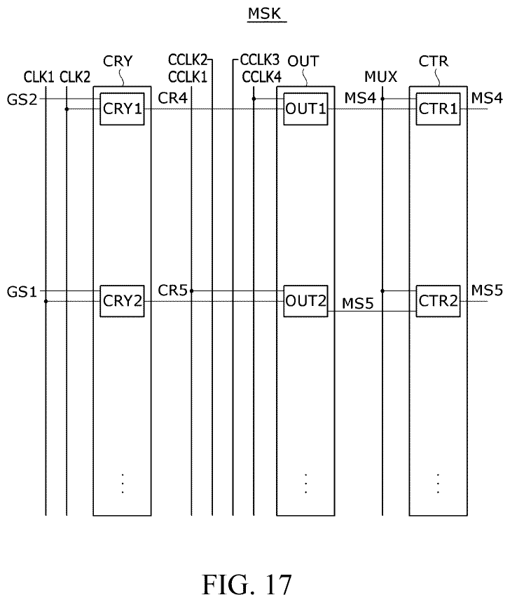

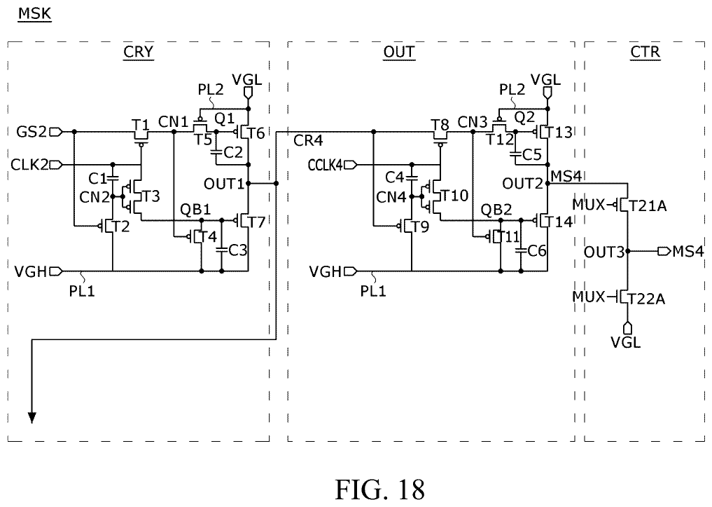

FIG. 17 is a block diagram showing a gate driver according to a third embodiment of the present disclosure. FIG. 18 is a diagram showing a detailed circuit of the output controller shown in FIG. 17.

Referring to FIGS. 17 and 18, which illustrates an example of signal transfer parts included in an output controller MSK of a gate driver according to a third embodiment of the present disclosure, the output controller may include a carry signal transfer part CRY, a control signal transfer part OUT, and a control signal selection part CTR.

The carry signal transfer part CRY and the control signal transfer part OUT of the third embodiment have the same configuration and operation as the carry signal transfer part and the control signal transfer part of the first embodiment, and thus a description thereof will be omitted.

The control signal selection part CTR may selectively output the control signal MS4 output from the control signal transfer part OUT or the low-potential voltage VGL. The control signal selection part CTR includes a twenty-first A transistor T21A and a twenty-second A transistor T22A.

The twenty-first A transistor T21A is turned on according to a potential of a MUX signal MUX and outputs the control signal MS4 to a third output node OUT3. The twenty-first A transistor T21A includes a gate electrode to which the MUX signal MUX is applied, a first electrode connected to the second output node OUT2, and a second electrode connected to the third output node OUT3.

The twenty-second A transistor T22A is turned on according to a potential of the MUX signal MUX and outputs the low-potential voltage VGL to the third output node OUT3. The twenty-second A transistor T22A includes a gate electrode to which the MUX signal MUX is applied, a first electrode connected to the third output node OUT3, and a second electrode connected to the second power line PL2.

The twenty-first A transistor T21A and the twenty-second A transistor T22A are turned on or turned off by the same MUX signal but are driven oppositely to each other; and accordingly, the twenty-first A transistor T21A is implemented as a p-channel TFT, and the twenty-second A transistor T22A is implemented as an n-channel TFT. However, the present disclosure is not limited thereto. For example, the twenty-first A transistor T21A may be implemented as an n-channel TFT, and the twenty-second A transistor T22A may be implemented as a p-channel TFT.

In this configuration, in the multi-frequency driving mode, the MUX signal MUX at a low-level voltage is applied to the control signal selection part CTR, and the control signal MS4 transferred from the control signal transfer part OUT is output as it is.

On the other hand, in the normal driving mode, the MUX signal MUX at a high-level voltage is applied to the control signal selection part CTR, and the low-potential voltage VGL is output.

The output controller according to the third embodiment of the present disclosure may all be applied as a control circuit for controlling outputs of the first scan driver, the second scan driver, and the fourth scan driver.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A gate driver comprising:
a control signal output part configured to generate a control signal based on a control clock signal and a carry signal;
a control signal selection part configured to transfer one of the control signal generated from the control signal output part or a low-potential voltage applied from a power line;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transferred from the control signal selection part.

2. The gate driver according to claim 1, wherein:
the control signal selection part includes a first transistor and a second transistor,
the first transistor includes a gate electrode configured to receive a first MUX signal, a first electrode connected to an output terminal of the control signal output part, and a second electrode connected to an output node, and
the second transistor includes a gate electrode configured to receive a second MUX signal, a first electrode configured to receive the low-potential voltage, and a second electrode connected to the output node.

3. The gate driver according to claim 2, wherein when driving frequencies are different for each display area of a display panel, the first MUX signal is set to a gate-on voltage and the second MUX signal is set to a gate-off voltage.

4. The gate driver according to claim 3, wherein the control signal output part outputs the control signal based on a modulated control clock signal.

5. The gate driver according to claim 2, wherein when driving frequencies are a same for each display area of a display panel, the first MUX signal is set to a gate-off voltage and the second MUX signal is set to a gate-on voltage.

6. The gate driver according to claim 1, wherein:
the control signal selection part includes a first transistor and a second transistor,
the first transistor includes a gate electrode configured to receive a MUX signal, a first electrode connected to an output terminal of the control signal output part, and a second electrode connected to an output node, and
the second transistor includes a gate electrode configured to receive the MUX signal, a first electrode configured to receive the low-potential voltage, and a second electrode connected to the output node.

7. The gate driver according to claim 1, further comprising:
a carry signal transfer part configured to output the carry signal based on a clock signal,
wherein the carry signal transfer part includes:
a first transistor having a gate electrode configured to receive the clock signal, a first electrode configured to receive a start pulse or a gate signal, and a second electrode connected to a first connection node;
a second transistor having a gate electrode configured to receive the start pulse or the gate signal, a first electrode connected to a second connection node, and a second electrode configured to receive a high-potential voltage;
a third transistor having a gate electrode connected to the second connection node, a first electrode configured to receive the clock signal, and a second electrode connected to a first-second control node;
a fourth transistor having a gate electrode connected to the first connection node, a first electrode connected to the first-second control node, and a second electrode configured to receive the high-potential voltage;
a fifth transistor having a gate electrode configured to receive the low-potential voltage, a first electrode connected to the first connection node, and a second electrode connected to a first-first control node;
a sixth transistor having a gate electrode connected to the first-first control node, a first electrode configured to receive the low-potential voltage, and a second electrode connected to a first output node; and
a seventh transistor having a gate electrode connected to the first-second control node, a first electrode connected to the first output node, and a second electrode configured to receive the high-potential voltage.

8. The gate driver according to claim 7, wherein:
the control signal output part includes an eighth transistor, a ninth transistor, a tenth transistor, an eleventh transistor, a twelfth transistor, a thirteenth transistor, and a fourteenth transistor,
the eighth transistor includes a gate electrode configured to receive the control clock signal, a first electrode connected to the first output node, and a second electrode connected to a third connection node,
the ninth transistor includes a gate electrode connected to the first output node, a first electrode connected to a fourth connection node, and a second electrode configured to receive the high-potential voltage,
the tenth transistor includes a gate electrode connected to the fourth connection node, a first electrode configured to receive the control clock signal, and a second electrode connected to a second-second control node,
the eleventh transistor includes a gate electrode connected to the third connection node, a first electrode connected to the second-second control node, and a second electrode configured to receive the high-potential voltage,
the twelfth transistor includes a gate electrode configured to receive the low-potential voltage, a first electrode connected to the third connection node, and a second electrode connected to a second-first control node,
the thirteenth transistor includes a gate electrode connected to the second-first control node, a first electrode configured to receive the low-potential voltage, and a second electrode connected to a second output node, and
the fourteenth transistor includes a gate electrode connected to the second-second control node, a first electrode connected to the second output node, and a second electrode configured to receive the high-potential voltage.

9. The gate driver according to claim 1, wherein:
the scan signal selection part includes a first transistor and a second transistor,
the first transistor includes a gate electrode connected to the first control node, a first electrode configured to receive the low-potential voltage, and a second electrode connected to an output node, and
the second transistor includes a gate electrode to which the control signal is applied, a first electrode configured to receive the scan signal, and a second electrode connected to the output node.

10. The gate driver according to claim 1, wherein:
the scan signal selection part includes a first transistor and a second transistor,
the first transistor includes a gate electrode configured to receive the control signal, a first electrode configured to receive the scan signal, and a second electrode connected to an output node, and
the second transistor includes a gate electrode connected to the second control node, a first electrode connected to the output node, and a second electrode connected to a high-potential voltage.

11. A display device comprising:
a display panel on which a plurality of data lines, a plurality of gate lines crossing the data lines, a plurality of power lines configured to receive different constant voltages, and a plurality of sub-pixels are arranged;
a data driver configured to supply a data voltage of pixel data to the data lines;
a gate driver configured to supply gate signals to the gate lines; and
a timing controller configured to control operation timings of the data driver and the gate driver,
wherein the gate driver includes:
a control signal output part configured to generate a control signal based on a control clock signal and a carry signal;
a control signal selection part configured to transfer one of the control signal generated from the control signal output part or a low-potential voltage applied from a power line;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transferred from the control signal selection part.

12. The display device according to claim 11, wherein:
the control signal selection part includes a first transistor and a second transistor,
the first transistor includes a gate electrode configured to receive a first MUX signal, a first electrode connected to an output terminal of the control signal output part, and a second electrode connected to an output node, and
the second transistor includes a gate electrode configured to receive a second MUX signal, a first electrode configured to receive the low-potential voltage, and a second electrode connected to the output node.

13. The display device according to claim 12, wherein:
when driving frequencies are different for each display area of the display panel, the timing controller generates the control clock signal and the first and second MUX signals, and
the first MUX signal is set to a gate-on voltage and the second MUX signal is set to a gate-off voltage.

14. The display device according to claim 13, wherein:
the timing controller is configured to generate a modulated control clock signal, and
the control signal output part is configured to output the control signal based on the modulated control clock signal.

15. The display device according to claim 12, wherein:
when driving frequencies are a same for each display area of the display panel, the timing controller does not generate the control clock signal but generates the first and second MUX signals, and
the first MUX signal is set to a gate-off voltage and the second MUX signal is set to a gate-on voltage.

16. The display device according to claim 11, wherein:
the control signal selection part includes a first transistor and a second transistor,
the first transistor includes a gate electrode configured to receive a MUX signal, a first electrode connected to an output terminal of the control signal output part, and a second electrode connected to an output node, and
the second transistor includes a gate electrode configured to receive the MUX signal, a first electrode configured to receive the low-potential voltage, and a second electrode connected to the output node.

17. The display device according to claim 11, further comprising:
a carry signal transfer part configured to output the carry signal based on a clock signal,
wherein the carry signal transfer part includes:
a first transistor having a gate electrode configured to receive the clock signal, a first electrode configured to receive a start pulse or a gate signal, and a second electrode connected to a first connection node;
a second transistor having a gate electrode configured to receive the start pulse or the gate signal, a first electrode connected to a second connection node, and a second electrode configured to receive a high-potential voltage;
a third transistor having a gate electrode connected to the second connection node, a first electrode configured to receive the clock signal, and a second electrode connected to a first-second control node;
a fourth transistor having a gate electrode connected to the first connection node, a first electrode connected to the first-second control node, and a second electrode configured to receive the high-potential voltage;
a fifth transistor having a gate electrode configured to receive the low-potential voltage, a first electrode connected to the first connection node, and a second electrode connected to a first-first control node;
a sixth transistor having a gate electrode connected to the first-first control node, a first electrode configured to receive the low-potential voltage, and a second electrode connected to a first output node; and
a seventh transistor having a gate electrode connected to the first-second control node, a first electrode connected to the first output node, and a second electrode configured to receive the high-potential voltage.

18. The display device according to claim 17, wherein:
the control signal output part includes an eighth transistor, a ninth transistor, a tenth transistor, an eleventh transistor, a twelfth transistor, a thirteenth transistor, and a fourteenth transistor,
the eighth transistor includes a gate electrode configured to receive the control clock signal, a first electrode connected to the first output node, and a second electrode connected to a third connection node,
the ninth transistor includes a gate electrode connected to the first output node, a first electrode connected to a fourth connection node, and a second electrode configured to receive the high-potential voltage,
the tenth transistor includes a gate electrode connected to the fourth connection node, a first electrode configured to receive the control clock signal, and a second electrode connected to a second-second control node,
the eleventh transistor includes a gate electrode connected to the third connection node, a first electrode connected to the second-second control node, and a second electrode configured to receive the high-potential voltage,
the twelfth transistor includes a gate electrode configured to receive the low-potential voltage, a first electrode connected to the third connection node, and a second electrode connected to a second-first control node,
the thirteenth transistor includes a gate electrode connected to the second-first control node, a first electrode configured to receive the low-potential voltage, and a second electrode connected to a second output node, and
the fourteenth transistor includes a gate electrode connected to the second-second control node, a first electrode connected to the second output node, and a second electrode configured to receive the high-potential voltage.

19. The display device according to claim 11, wherein:
the scan signal selection part includes a first transistor and a second transistor,
the first transistor includes a gate electrode connected to the first control node, a first electrode configured to receive the low-potential voltage, and a second electrode connected to an output node, and
the second transistor includes a gate electrode configured to receive the control signal, a first electrode configured to receive the scan signal, and a second electrode connected to the output node.

20. The display device according to claim 11, wherein:
the scan signal selection part includes a first transistor and a second transistor,
the first transistor includes a gate electrode configured to receive the control signal, a first electrode configured to receive the scan signal, and a second electrode connected to an output node, and
the second transistor includes a gate electrode connected to the second control node, a first electrode connected to the output node, and a second electrode connected to a high-potential voltage.
